(19) United States
(12) Patent Application Publication
(10) Pub. No.: US 2009/0109110 A1
(43) Pub. Date: Apr. 30, 2009

(54) Apparatus and Method for Providing Multiple High Gain Beams

(75) Inventors: Daniel G. Gonzalez, Topanga, CA (US); Leslie E. Oliver, Thousand Oaks, CA (US)

Correspondence Address: CROWELL & MORING LLP;INTELLECTUAL PROPERTY GROUP, P.O. BOX 14300, WASHINGTON, DC, 20044-4300, US

(73) Assignee: Malibu Research Associates, Inc., Camarillo, CA (US)

(21) Appl. No.: 11/933,096

(22) Filed: Oct. 31, 2007

(51) Int. Cl. H01Q 19/10; H01Q 13/02

(52) U.S. Cl. 343/779; 343/781 R

(57) ABSTRACT

A reflective antenna is provided according to one or more embodiments of the invention. In one embodiment, the reflective antenna may include a feedhorn arrangement configured for an operation frequency. According to another embodiment, the reflective antenna may include a curved reflective surface having a plurality of electromagnetically loading structures. The curved reflective surface may be configured to reflect incident electromagnetic energy to corresponding to the operation frequency relative to at least one focal point. In another embodiment, the reflective antenna may include a support structure configured to arrange the feedhorn arrangement and the curved reflective surface such that the antenna assembly may be configured to provide multiple electromagnetic beams exhibiting high gain relative to the at least one focal point.

### FIELD OF THE INVENTION

The present invention relates in general to reflective antennas, and more particularly to a high gain reflective antenna assembly configured to provide multiple beams.

### BACKGROUND

Conventional reflective antennas have been used for many applications including communications, radar, scanning, tracking, etc. Typical reflective antennas employ parabolic reflectors to focus electromagnetic energy to a particular focal point. Conventionally, reflective antenna gain may be proportional to the reflective area of the parabolic surface. Therein, a larger reflective surface is required to achieve a higher gain. However, increases in reflective area of a parabolic reflector may not be suitable for certain applications. Conventional reflective antennas can employ large reflective surfaces or expensive motors for focusing electromagnetic energy. Such conventional reflective antennas may be limited by manufacturing of large reflective surfaces and costs to prevent surface inaccuracies. Larger reflective surfaces can impose surface inaccuracies which lead to degradation of gain, especially at higher frequencies. In addition conventional reflective antennas do not teach or suggest providing a plurality of beams exhibiting high gain, nor reflective antenna employing a plurality of focal points.

Further, it has been suggested to electromagnetically emulate curved reflective surfaces of any geometry using a substantially planar microwave reflector antenna configuration. U.S. Pat. No. 4,905,014 issued to Gonzalez et al., Feb. 27, 1990, the contents of which are fully incorporated herein by reference, teaches a phasing structure emulating desired reflective surfaces regardless of the geometry of the physical surfaces to which the microwave phasing structure is made to conform, wherein the structure may be fabricated as a fraction of the wavelength of the operating frequency of the phasing surface. The aforementioned technology, marketed as Flat Parabolic Surface (FLAPS™) technology accomplishes the aforementioned function using a dipole antenna placed in front of a ground plane. However, such planar structures require large reflective surfaces at microwave operating frequencies and may be susceptible to scan degradation.

While conventional antenna structures teach phasing structures of multiple geometries and different surfaces, such structures struggle to provide multiple high gain beams.

### BRIEF SUMMARY OF THE INVENTION

Disclosed and claimed herein is a reflective antenna according to one or more embodiments of the invention. In one embodiment, the reflective antenna includes a feedhorn arrangement configured for an operation frequency. According to another embodiment, the reflective antenna includes a curved reflective surface having a plurality of electromagnetically loading structures. The curved reflective surface may be configured to reflect incident electromagnetic energy to corresponding to the operation frequency relative to at least one focal point. In another embodiment, the reflective antenna includes a support structure configured to arrange the feedhorn arrangement and the curved reflective surface such that the antenna assembly is configured to provide multiple electromagnetic beams exhibiting high gain relative to the at least one focal point.

Other aspects, features, and techniques of the invention will be apparent to one skilled in the relevant art in view of the following detailed description of the invention.

### BRIEF DESCRIPTION OF THE DRAWINGS

FIG. 1 depicts one or more embodiments of a reflective antenna;

FIG. 2 depicts a plan view of the reflective antenna of FIG. 1;

FIG. 3 depicts a simplified antenna arrangement according to one embodiment of the reflective antenna of FIG. 1;

FIG. 4 depicts a simplified antenna arrangement according to one embodiment of the reflective antenna of FIG. 1; and

FIG. 5 depicts a graphical representation of a scan diagram according to one embodiment of the reflective antenna of FIG. 1.

### DETAILED DESCRIPTION OF EXEMPLARY EMBODIMENTS

One aspect of the invention is to provide a reflective antenna configured to direct a plurality of beams exhibiting high gain. In one embodiment, the reflective antenna may include a curved reflective surface, a feedhorn arrangement and a support structure. The curved reflective surface may include a plurality of electromagnetic loading structures and a ground plane. According to another embodiment, the curved reflective surface may be configured to reflect incident electromagnetic energy to the plurality of focal points. For example, the curved reflective surface may reflect a plurality of high gain beams associated with the feedhorn arrangement. Similarly, it may be appreciated that electromagnetic energy incident on the curved reflective surface may be reflected to a plurality of focal points corresponding to the feedhorn arrangement. In certain embodiments, the curved reflective surface may be characterized as having a non-parabolic geometry. Further, the feedhorn arrangement may include one of a single feedhorn and a feedhorn array.

According to another embodiment, a reflective antenna may be configured to provide a reflective surface exhibiting a point of convergence for every degree of freedom corresponding to the contour of the reflective surface. In that fashion, the curved reflective surface may reflect a plurality of beams exhibiting high gain. In one embodiment, the curved reflective surface may be employed for scanning applications. Further, the substantially perfect reflective contour of curved a reflective surface may be employed to provide low scan degradation.

According to another aspect of the invention, a reflective antenna may be embodied in a compact structure for reflecting electromagnetic energy at high gain. In one embodiment, electromagnetic beams exhibiting high gain may be focused and/or reflected, without the use of a large reflective surface or the use of expensive motors. Further, the compact structure of the reflective antenna may be free of limitations imposed by large reflectors, including but not limited to, manufacturing large reflective surfaces and costs to prevent surface inaccuracies. To that end, the reflective antenna may be employed for scanning and tracking applications.

As used herein, the terms “a” or “an” mean one or more than one. The term “plurality” mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means any of the following: A; B; C; A and B; A and C; B and C; A, B and C. An exception to this definition will occur only when a combination of elements, functions, steps or acts are in some way inherently mutually exclusive.

Reference throughout this document to “one embodiment”, “certain embodiments”, “an embodiment” or similar term means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner on one or more embodiments without limitation.

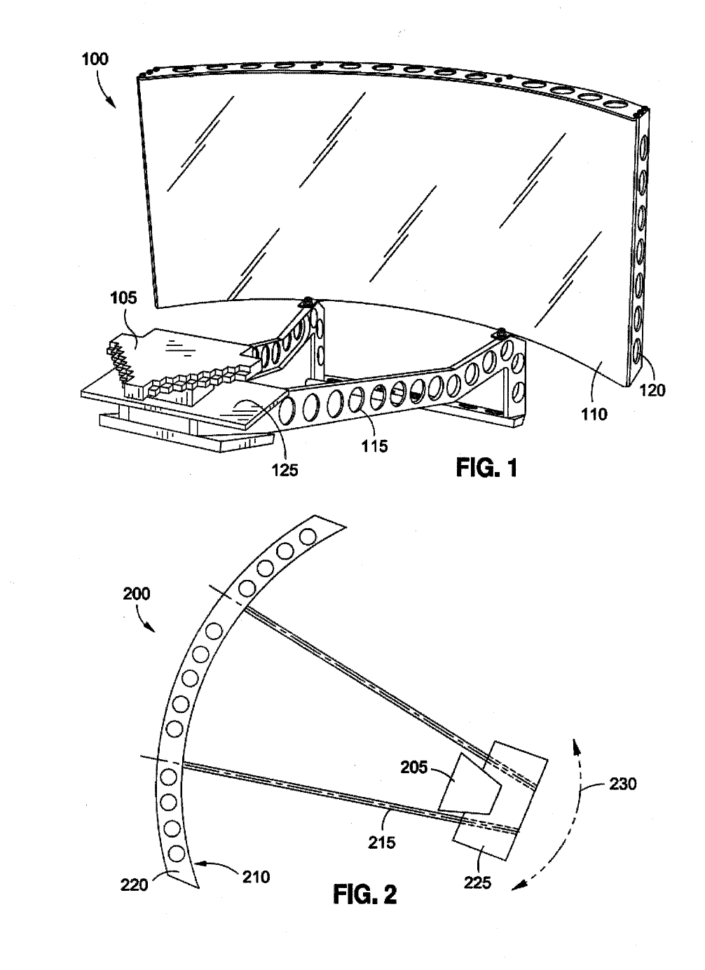

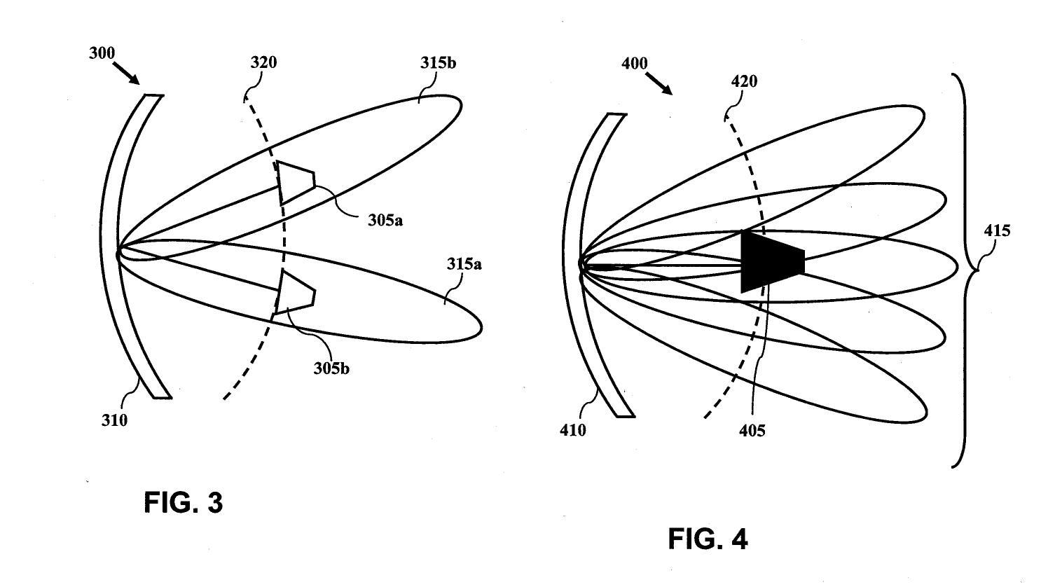

Referring now to FIG. 1, depicted is one embodiment of a reflective antenna 100 configured in accordance with the principles of the invention. As shown, reflective antenna 100 includes a feedhorn arrangement 105, a curved reflective surface 110 and support structure 115. In one embodiment, feedhorn arrangement 105 comprises one of a single feedhorn and a feedhorn array. Feedhorn arrangement 105 may be configured to transmit, or receive, electromagnetic energy to, or from, curved reflective surface 110. Further, feedhorn arrangement 105 may be coupled to a back-end system (not shown) for processing electromagnetic energy received. In one embodiment, the back-end system may provide processing circuitry or circuitry in general for reflective antenna 100. Similarly, feedhorn arrangement 105 may be configured to transmit electromagnetic energy received from the back end system. As shown, feedhorn arrangement 105 comprises a single assembly housing a plurality of feeds. Accordingly, feedhorn arrangement 105 may be provided by a machined structure arranging a plurality of separate feedhorns according to one embodiment of the invention. However, it may be appreciated that feedhorn arrangement 105 may be embodied as a plurality of feedhorns separately placed a fixed distance from curved reflective surface 110 as will be described below in more detail with reference to FIG. 3. According to another embodiment, feedhorn arrangement 105 may be configured for an operational range of 1-100 GHz. However it may be appreciated that reflective antenna may configured to employ other frequency values.

According to another embodiment of the invention, the curved reflective surface 110 of reflective antenna 100 may include an arrangement of electromagnetic loading structures. In one embodiment, the arrangement of electromagnetically-loading structures may be disposed on the curved reflective surface 110 to emulate a desired reflective geometry. Such electromagnetically-loading structures may vary in dimension, having an orientation and interspacing from each other. In certain embodiments, such electromagnetically-loading structures may correspond to the electromagnetically-loading structures disclosed in the previously-incorporated U.S. Pat. No. 4,905,014, the details of which are fully disclosed therein. By way of example, the arrangement of electromagnetically-loading structures may comprise an array of metallic patterns, where each metallic pattern having a cross (i.e., X) configuration with dimensions, orientation, and interspacing such that the desired reflective surface of selected geometry is obtained. Each metallic pattern may constitute a shorted crossed dipole.

According to another embodiment, curved reflective surface 110 may be an electrically thin surface. For example, an electrically thin phasing surface may provide electromagnetically emulating of a desired reflective surfaces regardless of the geometry of the physical surfaces to which the electrically thin microwave phasing structure is made to conform. As used hereinafter, the term “electrically thin” shall mean on the order of a fraction of the wavelength of the operating frequency of the microwave phasing structure.

According to another embodiment, the curved reflective surface 110 may be configured to reflect incident electromagnetic energy to the plurality of focal points. For example, curved reflective surface 110 may reflect a plurality of high gain beams associated with feedhorn arrangement 105. Similarly, it may be appreciated that electromagnetic energy incident on curved reflective surface 110 may be reflected to a plurality of focal points corresponding to feedhorn arrangement 105. In certain embodiments, curved reflective surface 110 may be characterized as having a non-parabolic geometry. In yet another embodiment, curved reflective surface 110 may include a ground plane. The ground plane may be place a distance from electromagnetic loading structures supported by curved reflective surface 110.

Continuing to refer to FIG. 1, support structure 115 of reflective antenna 100 may be configured to arrange feedhorn arrangement 105 a predetermined distance from curved reflective surface 110. In one embodiment, support structure 115 may be manufactured of aluminum. However, it may be appreciated that other materials may be employed for support structure 115. Additionally, support structure 115 may be mounted to a movable base such that antenna assembly 100 may be pointed in a particular direction. According to another embodiment, support structure 115 may include substructure 120 configured to support curved reflective surface 110. Substructure 120 may be coupled to support structure 115 by movable joint such that curved reflective surface 110 may be tilted. In that fashion, curved reflective surface 110 may be configured to direct electromagnetic energy to feedhorn arrangement 105 from various angles in the elevation plane. According to another embodiment, support structure 115 may include base 125 configured to arrange feedhorn arrangement 105. Base 125 may be coupled to support structure 115 by movable joint such that feedhorn arrangement 105 may be adjusted angularly and/or repositioned as discussed in more detail below with respect to FIG. 2. In that fashion, feedhorn arrangement 105 may be configured to transmit and receive electromagnetic energy from various angles in the azimuth plane in relation to the curved reflective surface 110.

Referring now to FIG. 2, a plan view is shown of a reflective antenna 200 (e.g., reflective antenna 100) according to one or more embodiments of the invention. As shown, reflective antenna 200 includes a feedhorn arrangement 205, a curved reflective surface 210 and support structure 215. Further, support structure 215 includes substructure 220 configured to support curved reflective surface 210. Additionally, support structure 215 includes include base 225 configured to arrange feedhorn arrangement 205. Base 225 may be coupled to support structure 215 by movable joint such that feedhorn arrangement 105 may be adjusted angularly and/or repositioned as indicated by direction 230. However, it may further be appreciated that feedhorn arrangement 205 may arranged in a fix position by base 225.

Referring now to FIG. 3, a simplified block diagram is provided of a reflective antenna 300 as may be employed by the reflective antenna 100 of FIG. 1. As shown, reflective antenna 300 includes a feedhorn arrangement (e.g., feedhorn arrangement 105) comprising a plurality of feedhorns 305a-b and a curved reflective surface 310 (e.g., curved reflective surface 110). In certain embodiments, curved reflective surface 310 may be characterized as having a non-parabolic geometry.

As shown in FIG. 3, the plurality of feedhorns 305a-b may be arranged a substantially equivalent distance from a particular point of curved reflective surface 310 as indicated by curve 320. Further, the plurality of feedhorns 305a-b may be arranged substantially equidistant from a center point of curve 320 according to another embodiment of the invention. In certain embodiments of the invention, feedhorns 305a-b may be configured to provide a plurality of high gain electromagnetic beams. As such, curved reflective surface 310 may be configured to reflect the plurality of high gain beams provided by feedhorns 305a-b shown as beams 315a-b respectively. Similarly, it may be appreciated that electromagnetic energy incident on curved reflective surface 310 may be reflected to a plurality of focal points corresponding to feedhorns 305a-b. Reflective surface 310 of reflective antenna 300 may be configured to exhibit a point of convergence for every degree of freedom corresponding to the contour of reflective surface 310.

According to another embodiment, feedhorns 350a-b may be coupled to a base (e.g., base 125) such that feedhorns 350a-b may be repositioned along curve 320. In yet another embodiment, feedhorns 350a-b may each comprise one of a single feedhorn and a feedhorn array.

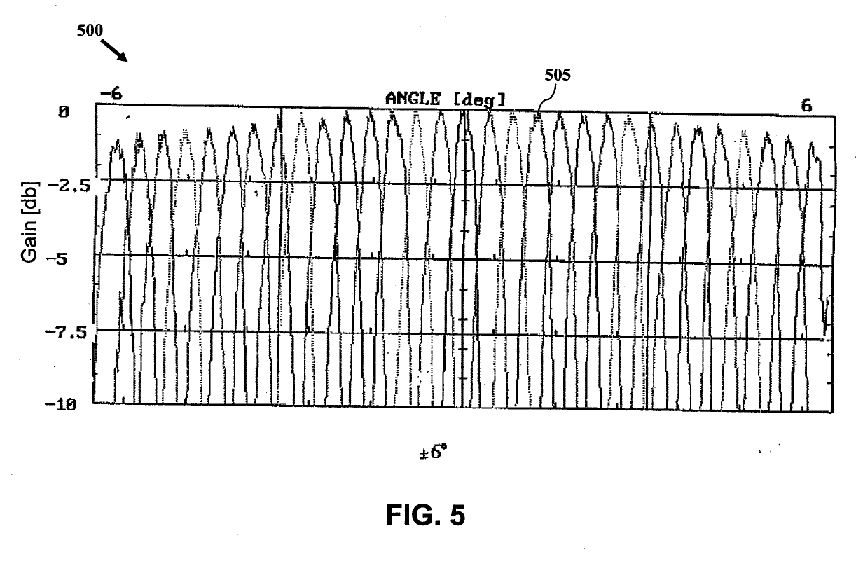

Referring now to FIG. 4, a simplified block diagram is provided of a reflective antenna 400 as may be employed by the reflective antenna 100 of FIG. 1. As shown, reflective antenna 400 includes a feedhorn arrangement 405 and a curved reflective surface 410. As shown in FIG. 4, the feedhorn arrangement 405 may be arranged a distance from reflective surface 410 as indicated by curve 420. In certain embodiments of the invention, feedhorn arrangement 405 may be configured to provide a plurality of high gain electromagnetic beams. As such, curved reflective surface 410 may be configured to reflect the plurality of high gain beams provided by feedhorn arrangement 405 shown as beams 415. The collection of beams 415 may provide a collective beam spanning a wide angle as described below in more detail with respect to FIG. 5. Similarly, it may be appreciated that electromagnetic energy incident on curved reflective surface 410 may be reflected to a plurality of focal points corresponding to feedhorn arrangement 405. In that fashion, reflective surface 410 of reflective antenna 400 may be configured to exhibiting a substantially perfect reflective contour. To that end, curved reflective surface 410 may provide a substantially perfect focal point for every degree of freedom. Further, the substantially perfect reflective contour of curved reflective surface 410 may be employed to provide low scan degradation.

Referring now to FIG. 5, a graphical representation 500 of beam energy 505 exhibited by a plurality of beams provided by one embodiment of a reflective antenna of the present invention (e.g., reflective antenna 100) in relation to the reflective antennas azimuth angle is depicted. In one embodiment, beam energy 505 may correspond to a collection of beams (e.g., collection of beams 415) spanning a wide angle. In that fashion, a directional antenna (e.g., directional antenna 100) may be configured to provide a beam exhibiting high gain. Although graphical representation 500 characterizes beam energy 505 as having particular gain values, it may be appreciated that a reflective antenna (e.g., reflective antenna 100) as provided by one embodiment of the invention may provide beams having a gain value in the range of 30 to 40 dB. Similarly, graphical representation 500 characterizes beam energy 505 as having ±6° scan angle. However, it should be appreciated that a reflective antenna (e.g., reflective antenna 100) as provided by one embodiment of the invention may be configured to provide other scan values. Additionally, graphical representation 500 characterizes beam energy 505 as having a particular number of beams. However, it should be appreciated that a reflective antenna (e.g., reflective antenna 100) as provided by one embodiment of the invention may be configured to provide other number values of beams.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Trademarks and copyrights referred to herein are the property of their respective owners.

What is claimed is:

1. A reflective antenna comprising:
a feedhorn arrangement configured for an operation frequency;
a curved reflective surface having a plurality of electromagnetically loading structures, wherein the curved reflective surface is configured to reflect incident electromagnetic energy relative to at least one focal point, the electromagnetic energy corresponding to said operation frequency; and
a support structure configured to arrange said feedhorn arrangement and said curved reflective surface such that the reflective antenna is configured to provide a plurality of electromagnetic beams exhibiting high gain relative to the at least one focal point.

2. The reflective antenna assembly of claim 1, wherein the feedhorn arrangement comprises one of an single feedhorn and a feedhorn array.

3. The reflective antenna assembly of claim 1, wherein the curved reflective surface conforms to a non-parabolic geometry.

4. The reflective antenna assembly of claim 1, wherein the at least one focal point provided by the curved reflective surface corresponds a point of convergence for every degree of freedom corresponding to the contour of the curved reflective surface.

5. The reflective antenna assembly of claim 1, wherein said curved reflective surface further comprises a ground plane.

6. The reflective antenna assembly of claim 1, wherein said curved reflective surface is configured to provide a scan pattern exhibiting substantially low scan degradation associated with the plurality of electromagnetic beams exhibiting high gain.

7. The reflective antenna assembly of claim 1, wherein said support structure is configured to tilt the curved reflective surface in the elevation plane.

8. The reflective antenna assembly of claim 1, wherein said support structure is configured to position said feedhorn arrangement offset from a central point of the curved reflective surface in the azimuth plane.

9. The reflective antenna assembly of claim 1, wherein relative to at least one focal point comprises at least one of to and from the at least one focal point.

10. A reflective antenna comprising:
a plurality of feedhorns configured for an operation frequency;
a curved reflective surface having a plurality of electromagnetically loading structures, wherein the curved reflective surface is configured to reflect incident electromagnetic energy relative to at least one focal point, the electromagnetic energy corresponding to said operation frequency; and
a support structure configured to arrange said plurality of feedhorns at the at least one focal point and to arrange said curved reflective surface such that the reflective antenna is configured to provide a plurality of electromagnetic beams exhibiting high gain relative to the at least one focal point.

11. The reflective antenna assembly of claim 10, wherein the each of the plurality of feedhorns comprises one of an single feedhorn and a feedhorn array.

12. The reflective antenna assembly of claim 10, wherein the curved reflective surface conforms to a non-parabolic geometry.

13. The reflective antenna assembly of claim 10, wherein the at least one focal point provided by the curved reflective surface corresponds to a point of convergence for every degree of freedom corresponding to the contour of the curved reflective surface.

14. The reflective antenna assembly of claim 10, wherein said curved reflective surface further comprises a ground plane.

15. The reflective antenna assembly of claim 10, wherein said curved reflective surface is configured to provide a scan pattern exhibiting substantially low scan degradation associated with the plurality of electromagnetic beams exhibiting high gain.

16. The reflective antenna assembly of claim 10, wherein said support structure is configured to tilt the curved reflective surface in the elevation plane.

17. The reflective antenna assembly of claim 10, wherein said support structure is configured to position said feedhorn arrangement offset from a central point of the curved reflective surface in the azimuth plane.

18. The reflective antenna assembly of claim 10, wherein relative to at least one focal point comprises at least one of to and from the at least one focal point.
